(19) United States
(12) Patent Application Publication
(10) Pub. No.: US 2016/0159286 A1
(43) Pub. Date: Jun. 9, 2016

(54) Rear View Mirror System and Related Methods

(71) Applicant: Jerry Harville, Chandler, AZ (US)

(72) Inventor: Jerry Harville, Chandler, AZ (US)

(21) Appl. No.: 14/921,043

(22) Filed: Oct. 23, 2015

Related U.S. Application Data
(60) Provisional application No. 62/089,498, filed on Dec. 9, 2014.

(51) Int. Cl. B60R 1/12; H04N 7/18; B60Q 9/00; B60R 1/04

(52) U.S. Cl. CPC B60R 1/12; B60R 1/04; H04N 7/185; B60Q 9/00; B60R 2001/1215; B60R 2001/1253

(57) ABSTRACT

A rear view mirror system includes a body attached to a front windshield of a wheeled vehicle. The body includes a rear side having a rear view mirror and a front side, opposite the rear side, having a display which displays a message in response to the selector being selected. The message may include: a message that a light is out or broken; a message that a gas cap is off or that a gas panel is open; a message that a tire is flat or low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle, and/or; a message indicating that another driver may proceed.

### CROSS REFERENCE TO RELATED APPLICATIONS

This document claims the benefit of the filing date of U.S. Provisional Patent Application No. 62/089,498, entitled “Rear View Mirror System and Related Methods,” naming as first inventor Jerry Harville, which was filed on Dec. 9, 2014, the disclosure of which is hereby incorporated entirely herein by reference.

### BACKGROUND

1. Technical Field

Aspects of this document relate generally to rear view mirrors, such as for vehicles. More specific implementations relate to rear view mirrors for automobiles.

2. Background Art

Many vehicles include one or more rear view mirrors. A rear view mirror generally allows a driver of a vehicle to see a portion of a road or other area (including other vehicles) behind, or at least partially behind, the vehicle which the driver is maneuvering.

### SUMMARY

Implementations of rear view mirror systems may include: a body including: a rear side having a rear view mirror; a front side opposite the rear side, the front side having a display configured to display a message, and; a selector, and; an attachment member configured to attach the body to a front windshield of a wheeled vehicle; wherein the display is configured to display the message in response to a driver of the wheeled vehicle selecting the selector.

Implementations of rear view mirror systems may include one, all, or any of the following:

The selector may be included on the rear side of the body.

The message may be selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle; a message indicating that another driver may proceed, and; a customized message (i.e., a message typed in or dictated by a user).

The message may be displayed in a reverse format so that it will be seen in a forward format when viewed through a mirror.

The message may be displayed in a forward format so that it will be seen in the forward format when viewed directly and not reflected through a mirror.

The selector may include a push button and may include a description descriptive of the message.

The message may include one or more alphanumeric characters.

The message may include one or more non-alphanumeric symbols.

A coupler may be included on the body and may be configured to electrically couple the rear view mirror system with one of a power source and an external electronic device.

A camera may be included on the front side of the body.

Implementations of rear view mirror systems may include: a body attached to a front windshield of a wheeled vehicle with an attachment member, the body including: a rear side having a mirror; a front side opposite the rear side and having a display facing a front of the wheeled vehicle, and; a plurality of selectors, each selector causing the display to display one of a plurality of predetermined messages to a person outside and in front of the wheeled vehicle in response to being selected, at least one of the predetermined messages including alphanumeric characters; wherein the rear view mirror system displays at least one of the predetermined messages in a reverse format so that it may be seen in a forward format when viewed through a mirror.

Implementations of rear view mirror systems may include one, all, or any of the following:

The plurality of selectors may include push buttons located on the rear side of the body.

The plurality of predetermined messages may include a message selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle, and; a message indicating that another driver may proceed.

At least one of the predetermined messages may include one or more non-alphanumeric symbols.

A coupler may be included on the body to communicatively couple the rear view mirror system with an external electronic device.

A camera may be included on the front side of the body.

Implementations of methods of use of a rear view mirror system may include: receiving an input from a driver of a wheeled vehicle at a selector on a rear side of a body of a rear view mirror system, the rear side facing the driver, and; displaying, in response to receiving the input, a message on a front side of the body of the rear view mirror system opposite the rear side; wherein the rear side of the body of the rear view mirror system includes a rear view mirror.

Implementations of methods of use of a rear view mirror system may include one, all, or any of the following:

The message may be selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle, and; a message that another driver may proceed.

The message may include one or more alphanumeric characters.

The message may be displayed in reverse format so that it will be seen in forward format when viewed through a mirror.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a rear view of an implementation of a rear view mirror system;

FIG. 2 is a front view of an implementation of a rear view mirror system;

FIG. 3 is a front view of an implementation of a rear view mirror system;

FIG. 4 is a right side view of an implementation of a rear view mirror system;

FIG. 5 is a right side view of an implementation of a rear view mirror system in an installed configuration;

FIG. 6 is an illustration of logo symbols that may be used with implementations of rear view mirror systems;

FIG. 7 includes cropped front views of implementations of rear view mirror systems showing only display portions;

FIG. 8 is a top view of a representation of vehicles and a pedestrian discussed in conjunction with an implementation a method of use of a rear view mirror system;

FIG. 9 is a front view of vehicles and a driver discussed in conjunction with an implementation of a method of use of a rear view mirror system;

FIG. 10 is a front view of vehicles and drivers discussed in conjunction with an implementation of a method of use of a rear view mirror system;

FIG. 11 is a rear view of vehicles and drivers discussed in conjunction with an implementation of a method of use of a rear view mirror system, and;

FIG. 12 is a rear view of vehicles and drivers discussed in conjunction with an implementation of a method of use of a rear view mirror system.

### DESCRIPTION

This disclosure, its aspects and implementations, are not limited to the specific components, assembly procedures or method elements disclosed herein. Many additional components, assembly procedures and/or method elements known in the art consistent with the intended rear view mirror systems and related methods will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such rear view mirror systems and related methods, and implementing components and methods, consistent with the intended operation and methods.

Implementations of rear view mirror systems and related methods relate to a body having a mirror on a rear side and a display on a front side opposite the rear side.

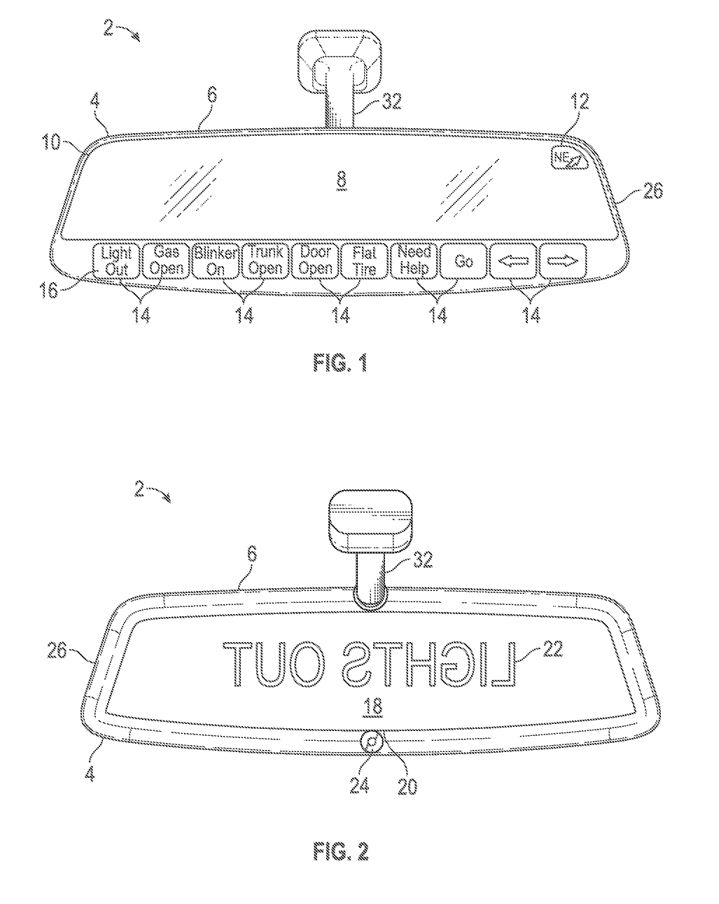

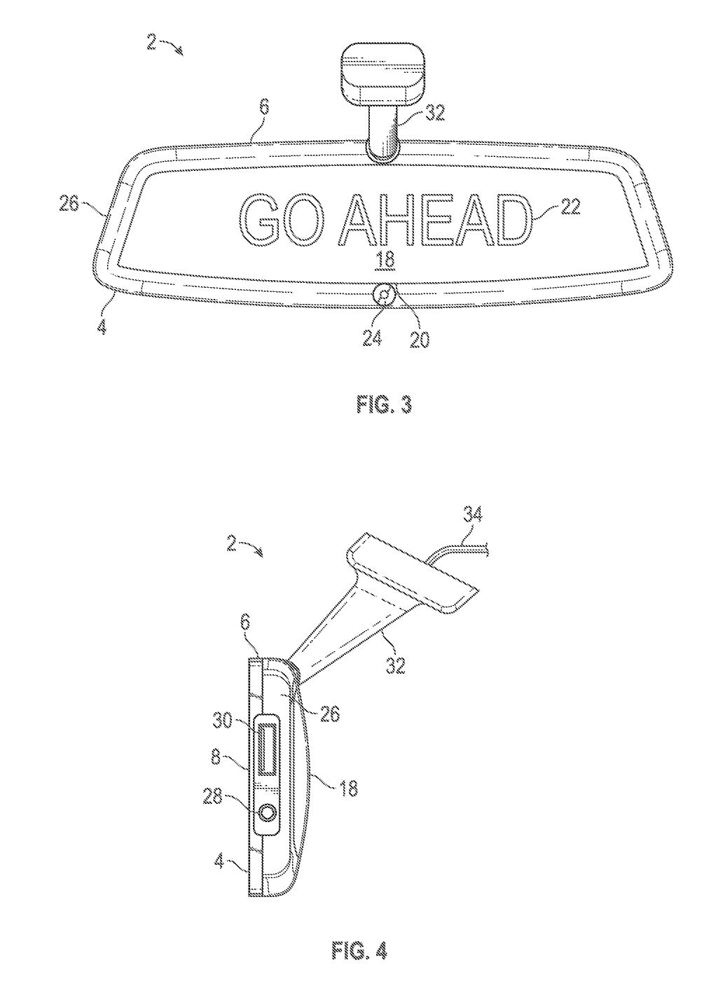

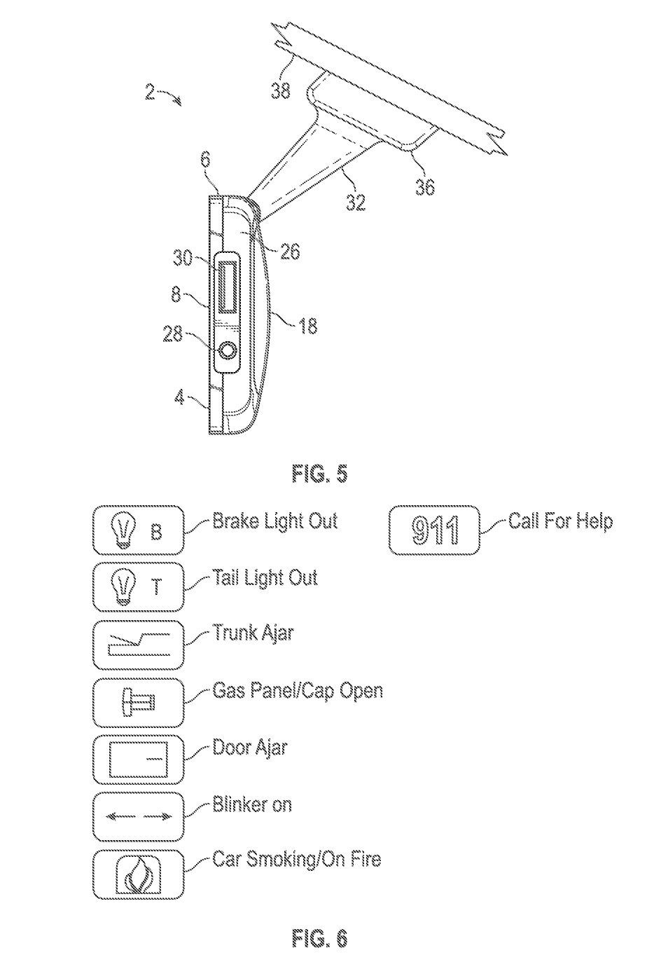

Referring now to FIGS. 1-5, in implementations a rear view mirror system (system) 2 includes a body 4 having a rear side 8 with a mirror 10 thereon and a front side 18 opposite the rear side 8. A neck 32 couples the body 4 to an attachment member 36 which in turn couples to a front windshield 38 of a vehicle such as, by non-limiting example, a passenger automobile.

System 2 includes a mirror 10 located on a rear side 8 of the body 4 or, in other words, generally facing towards a rear of the vehicle, so that a user driving the vehicle may look into the mirror 10 and see, reflected, a view through the rear windshield, such as to see vehicles, obstacles, pedestrians and the like behind the driver's vehicle. The mirror is accordingly, in implementations, a rear view mirror. A direction indicator 12 indicates a direction in which the vehicle is travelling either by common designations of N, NE, NW, W, SW, S, SE, E and/or using an arrow (relative to North), and/or using angular measurements in degrees such as are common on a directional compass, and/or the like. The direction indicator 12 may show the designations and other elements using display elements including light elements, which may include light emitting diodes (LEDs), a liquid crystal display (LCD), or any other display now known or hereafter discovered.

The neck 32 at the junction with the body 4 and/or at the junction with an attachment member 36 may have adjustable mechanisms such as to allow the body 4 to be positioned according to the desire of the driver, so as to best position the mirror 10 to see behind the vehicle. This may be accomplished, by non-limiting example, using a ball joint with a proper level of friction so that the body 4 can be moved to desired positions but will retain a position once placed therein. In implementations the attachment member 36 could be excluded and the neck 32 could be coupled directly to the front windshield 38 without any intermediary element or, in other implementations, the neck 32 could be excluded and the body 4 could be coupled directly to the attachment member 36. In other implementations the neck 32 and attachment member 36 could both be excluded and the body 4 could be coupled directly to the front windshield—in such implementations, as in other implementations described herein, the mirror 10 may be coupled to the body 4 using an adjustable attachment member, such as a medium-friction ball joint, so that the mirror 10 may be positioned in various positions within or relative to the body 4.

In implementations the neck 32 is coupled to the body 4 at a top 6 of the body 4 instead of at a front side 18 of the body 4 so as to not obstruct the front side 18. This may maximize the surface area of the front side 18 that is available for a display 20. In other implementations the neck 32 could be directly coupled fully or party at the front side 18 though this may in some implementations reduce the surface area of the front side 18 which is available for the display 20.

The system 2 receives power either from an internal source, such as batteries placed within a battery receptacle of the housing, or through a power cord coupled to the vehicle battery or another electricity source of the vehicle. Referring to FIG. 4, the power cord 34 may be routed to the system 2 within a hollow portion of the neck 32, such as to power the display 20 and other elements of the system 2 as described herein. The power cord 34 could alternatively be routed outside the neck 32, such as adjacent to the outside of the neck 32, though routing the power cord within the neck may be more aesthetically pleasing to the end user. The power cord may be routed upwards from the system 2 and between an interior ceiling and a roof of the vehicle and, from there, down some side member or other component to be coupled to the vehicle's battery or other power source. A cord covering element could be placed between the system 2 and the ceiling of the vehicle to provide a more aesthetically pleasing look. In some implementations the system 2 could be coupled directly to the ceiling instead of to a front windshield and the power cord could be routed up through an opening or hole in the ceiling, down some side member to a power source such as the vehicle battery, or coupled with electrical wiring that powers the vehicle dome light, and so forth. In some implementations the system could include photovoltaic (PV) panels or the like, such as on the front side (though this may take up some of the display area) or on the top of the body, and the power cord could couple the PV panels with the system or to rechargeable batteries of the system (and in such a case the power cord may not need to extend outside the system at all).

Attachment member 36 may be coupled to the front windshield 38 using an adhesive, using a suction fit, using screws or bolts or other couplers that pass through holes in the windshield, using a high power magnet system, and/or using any other coupling mechanism.

Referring to FIG. 1, a number of selectors 14 are disposed on the front side of the body 4. In other implementations there could be one or more selectors 14 disposed on other portions of the body 4 such as on a right side 26, on a left side opposite the right side 26, on the top 6, on the front side 18, and/or on a bottom side, etc., and may accomplish a variety of purposes. The selectors 14 in implementations are designed to, in response to being selected, generate a message 22 on the display 20 to be displayed to one or more persons outside the vehicle. The selectors 14 may be push buttons, switches, knobs, capacitive sensors, and the like.

In the implementations shown in the drawings each selector 14, when selected, displays a single message 22. A description 16 of the message 22 to be displayed may be printed or otherwise representatively indicated on the selector 14. The description 16 may for example include words, numbers and/or symbols. Some representative descriptions 16 are shown on FIG. 1, each representing a message 22 that will be displayed to a driver of another vehicle, or a pedestrian, or the like.

For example, the leftmost selector 14 includes the description 16 of “Light Out,” and this selector, when selected, may display an associated message 22 on the display 20 to indicate to another driver that one of the lights of his/her vehicle is not functioning properly. The message 22 may include the same characters or symbol as the description 16 or it may be slightly different. In the case of the “Light Out” selector 14 the displayed message 22 may be something similar to: “Light Out,” “You have a light out,” “Lights Out,” “Broken Light,” or the like.

Naturally, depending on how the message 22 is viewed by the other driver, the message 22 may need to be displayed in regular form or in backwards/reverse form, such as shown in FIG. 2. If, for example, referring to FIG. 8, the message is displayed to a driver in a forward facing vehicle (vehicle) 42, relative to the system vehicle (vehicle) 40 (which is the vehicle having system 2), then the driver of forward facing vehicle 42 will most likely be viewing the message 22 reflected through the rear view mirror or a side mirror of forward facing vehicle 42. In this case the message 22 would be best displayed in backwards form so that it will be reflected in normal form to the driver of forward facing vehicle 42. If, however, the message 22 is displayed to a pedestrian 46 or to a driver of a rear facing vehicle (vehicle) 44, the message 22 would be best displayed in regular (not backwards) form.

System 2 may include a selector for the driver of the system vehicle 40 to select the direction in which the message should be displayed. In implementations system 2 may automatically display the message in backwards or forwards form depending on the message selected. For example, some of the messages may be more likely to be displayed to a forward facing vehicle 42 (i.e., a vehicle facing the same direction as the vehicle from which the message is displayed), such as a message that a trunk is open, a rear light is out, a brake light is out, a rear blinker is on, a rear tire is flat or low, and so forth. Other messages may be more likely to be displayed to a rear facing vehicle 44 (i.e., a vehicle facing the opposite direction of the vehicle from which the message is displayed), such as a message that brights are on, a front blinker is on, a front light or headlight is out, a front tire is flat or low, and so forth.

Some messages may be more likely to be displayed to a pedestrian 46, such as a message to “go ahead” and cross the street. In such cases in which the intended recipient of the message 22 can be predetermined based on the nature of the message, system 2 may automatically display the message in the appropriate direction for that intended recipient. For example if the message, by its nature, is more likely to be displayed to a forward facing vehicle it may by default be displayed in reverse form, and if the message by its nature is more likely to be displayed to a rear facing vehicle or a pedestrian it may by default be displayed in forward form. In implementations, however, a user may manually change the direction of display of the message when appropriate. In cases where the message 22 could be intended for more than one of the potential recipient types, the user of the system 2 may select which direction the text is displayed in or, alternatively, the message may alternate between forward and backward versions, such as blinking between such versions, so that any viewer, whether viewing the message head-on or through a mirror, would be able to see it properly.

In some cases the system 2 could have different selectors 14 for different recipient types. For example there is only one row of selectors 14 on the body 4 shown in FIG. 1, but in implementations there could be one row intended for a forward facing vehicle 42, one for a rear facing vehicle 44, and one for a pedestrian 46, or any combination thereof In some implementations every message related to the status or damage or condition of another vehicle may be displayed in backwards or reverse format, and only a few messages unrelated to the condition of a vehicle (such as “Go Ahead” or the like) related to conveying a message to a car waiting to turn or proceed at a four way stop (such as a stop with stop signs or streetlights), or the like, may be displayed frontwards. In other implementations, however, as described above, there may be many messages configured to be displayed to drivers of rear facing vehicles, even those related to the condition of a vehicle.

Ten selectors 14 are shown in FIG. 10 but as indicated there may be more or less than ten and FIG. 10 simply shows a representative example. Although each selector 14 is shown as corresponding with a single message 22, in implementations one or more selectors could correspond with more than one message 22. For example a selector could be configured as a scrolling button that scrolls between a plurality of messages and that, once scrolled to any specific message, then displays that message. The scrolling functionality could be accomplished with a knob or a push-button or capacitive sensor where a short push or touch scrolls to the next description, 16, which may be displayed such as with an electronic display on the selector 14 or another portion of the rear side 8, while a long push or touch selects that description 16 to display the associated message 22. Alternatively, a knob may be turned to rotate between messages and then pushed in to display the selected message. Naturally, many other configurations are possible and these are only representative examples.

Selectors 14 may have fixed descriptions and/or fixed messages associated with those descriptions, or in some implementations one or more of the selectors 14 may be customizable or otherwise programmable to display a customized message. In other implementations each selector may be able to be customized to display one of a plurality of predetermined messages selected from a master list of possible messages, in a similar manner to how a car radio button may be customized to select one radio frequency from a plurality of predetermined frequencies and then may be later changed when desired. This programming could be done in any manner, such as using a knob or other item to scroll or alternate between preprogrammed messages, and then long pressing or long touching a selector to program it to that message, or in another manner.

As may be understood, the system may be configured to allow a user to enter any customized message (for example “EMERGENCY—GOING TO HOSPITAL” or “PREGNANT—EMERGENCY” or “LATE FOR FLIGHT” or the like) using selectors which allow the user to select one character at a time to select the message. In some implementations the system could have a voice activated element that allows a user to dictate a word or phrase to be displayed for a certain message and the system may then compose the message using standard alphanumeric characters, allowing the user to make edits to the transcribed version as appropriate. In some implementations the display may alternate between showing a message and flashing a bright light of any or a number of colors to notify other drivers of an emergency. For example in an implementation in which a driver is driving to the hospital due to an emergency such a flashing light along with the message may alert to other drivers that it would be appropriate for them to yield so that the driver could get to the hospital quickly.

One of the selectors 14 may be a camera button to take a photo or video using camera 24 which is located on the front side 18 of the body 4. There may be one selector button to take a photo and another to take a video, or a single selector may take a photo with a short press/touch and a video with a long press/touch or a double touch, or the like. In implementations in which a video is taken the system 2 may include memory and may be continuously recording in real time but deleting all recordings after a certain amount of time has passed unless a user selects a selector that causes a recording, taken in the past, to be more permanently recorded (or otherwise to prevent it from being erased). For instance, the camera could continuously record, but automatically delete all recordings that are over 5 minutes old but, if a user uses a camera selector, the system 2 may abstain from deleting the last 5 minutes of recording, and may additionally refrain from deleting the next 5 or so minutes of recording (or an end time selected by the user such as by using a selector to stop the “permanent” capture). This may be useful, for instance, if the vehicle is in an accident, or the user witnessed a crime, or witnessed an accident, and so forth. In implementations system 2 may be configured to automatically perform this saving of relevant video when the vehicle is in a crash, such as in response to motion sensors, or the airbag being deployed, or the bumper being hit, and so forth.

In some implementations the photo or video data could be automatically uploaded, such as through a mobile device coupled with the system 2 using BLUETOOTH, a physical cable, or another mechanism, to a mobile device, or to an external server through the internet using the mobile device, or the like.

Coupler 30 (which may be a slot) on the right side 26 of the body 4 may be used to retrieve camera or video memory or for programming, power, or communicative purposes. For instance coupler 30 may be a universal serial bus (USB), mini USB, micro USB, or other type of slot, proprietary or non-proprietary, that may be used for memory sticks or cards or other memory devices, or for communicatively or electrically coupling an external device such as a smart phone or tablet or laptop or other external electronic device, or the like, to the system 2, or for electrically coupling the system with a power source, etc. For example a cord could couple the coupler 30 to a cigarette lighter to power the system 2, or a cord could couple a smart phone to the system using coupler 30 to control or program the system, etc. Coupler 30 may additionally or alternatively be used to couple the system 2 with a controller. The controller may include one or more integrated circuits and may include commands and protocols to control the system 2 in various ways such as, by non-limiting example, displaying predetermined descriptions on the selectors, controlling which messages are available for display on the display 20, and the like. Advertisements may also be displayed on display 20, such as to offset the cost of system 2 or to allow a driver to sell advertisement space/time for the display if desired, and this may also be controlled by the controller.

In some implementations a user could switch out one controller for another to change the system's controls or settings, or in implementations the controller may be wirelessly linked to a server that controls the controller, such as through cell tower or other wireless communications, to change the settings and/or controls of the controller and, thus, the system 2. In still other implementations the controller could be reprogrammed through communications with a smart phone or other mobile device, such as using BLUETOOTH communications with a mobile device, while the mobile device is in relatively close proximity with the controller (i.e., within BLUETOOTH range) and while or after the mobile device receives instructions through cell towers or through a wireless or other network from a server to change or otherwise reprogram the controller. As indicated herein, the controller may control the potential messages 22 that may be displayed, advertisements that may be displayed, the descriptions 16 on the selectors, and the like. In some implementations the controller may be fixedly coupled with or within the body 4 and, therefore, not removable through coupler 30. For example the controller may be integrally formed within the body as part of an integrated circuit, and the body may further include an internal or integrated wireless element to allow external devices, such as a smart phone or other mobile device, to communicate with the internal controller via the wireless element.

In some implementations a user could pick from a number of preconfigured system settings, each of which includes a number of configurations for selectors and displayed messages. For instance there may be a preconfigured selectable system setting for a person who regularly must visit the doctor or emergency room, a preconfigured setting for a pregnant woman, a preconfigured setting for a police or military vehicle, a preconfigured setting for a student driver, and so forth. In some cases preconfigured settings may come in software “packages” and/or may be downloadable and/or purchasable through an application on a mobile device or otherwise through the internet and downloaded to memory of the system 2 wirelessly or through a wired connection with the mobile device or a computer to control the system 2.

As indicated above the device could be used for emergency vehicles, such as a firefighting vehicle, a police vehicle, an ambulance, and so forth, and may display messages appropriate to such settings. For example the light flashing configuration described above would be useful for emergency vehicles. System 2 may be configured to automatically rotate messages between various languages, such as between English and Spanish in areas where there are both English and Spanish speakers, and/or between other languages in areas where there are other languages spoken. A police vehicle using the system 2 in this manner could benefit by being able to display multiple languages. For example a police officer wishing a person to step out of a vehicle may audibly make such a command through a megaphone or the like, but if the person does not speak the language of the officer the recipient may not understand. If the message is displayed on the system 2 in various languages the person may then understand and be able to comply, and avoid a precarious situation. Even in non-police settings the ability to have the messages displayed in multiple languages may be useful to facilitate effective communication in multilingual areas or when driving in a foreign-language location or country.

A switch 28 may be included on the right side 26 or any other portion of the system 2 to toggle the system 2 between and on and an off state. This may be used, by non-limiting example, to preserve battery life when system 2 is run using internal batteries or is otherwise not powered by a power source of the vehicle.

Advertisements may be provided by the provider of the system 2 and may result in lower cost of the system 2 to the end user and/or may result in payment to the end user in exchange for allowing the advertisements to be displayed, as disclosed to some extent above. In some implementations the advertisements could be removed by the user paying a fee to the provider of the system 2 to have an “ad-free” system.

As indicated, in some implementations the user could create one or more custom messages. In some cases these messages could include any characters, words, numbers and/or symbols selected or designed by the user. As also indicated, the system 2 may interact with a user's smart phone or other mobile device, such as through a BLUETOOTH or other wireless or wired connection and using a software application of the smart phone or device, to customize one or more messages, to customize one or more descriptions 16, and/or to customize any other settings of the system 2.

FIG. 1 shows a number of representative descriptions 16, which include, going from left to right: the wording “Light Out” to display a message that a light is out; the wording “Gas Open” to display a message that a gas cap is off or gas panel is open; the wording “Blinker On” to display a message that a blinker is on; the wording “Trunk Open” to display a message that a trunk is open; the wording “Door Open” to display a message that a vehicle door is open; the wording “Flat Tire” to display a message that a tire is flat; the wording “Need Help” to display a message that a driver or occupant of system vehicle 40 needs assistance; the wording “Go” to display a message to a driver of a rear facing vehicle 44 that he/she may proceed, such as at a two or four-way stop; a non-alphanumeric symbol such as a left arrow to display a message to a driver of a forward facing vehicle 42 that he/she is clear to veer left to switch lanes into the lane of, and in front of, system vehicle 40, and; a right arrow to display a message to a driver of a forward facing vehicle 42 that he/she is clear to veer right to switch lanes into the lane of, and in front of, system vehicle 40.

As indicated previously, the actual messages 22 displayed in response to selecting these selectors 14 bearing these descriptions 16 may not be the same wording or symbols as are in the descriptions themselves.

FIG. 6 gives a number of logo symbols that may be used as descriptions 16 such as: a symbol of a light bulb and the letter “B” to display a message that a brake light is out; a symbol of a light bulb and the letter “T” to display a message that a tail light is out; a symbol of an open trunk to display a message that a trunk is open or is ajar; a symbol of a gas cap to display a message that a gas cap or gas panel is open; a symbol of a vehicle door to display a message that a vehicle door is ajar or is open; a symbol of arrows to display a message that a blinker or turn signal is on (i.e., to encourage the recipient to turn off their blinker, turn signal, etc.); a symbol of a fire to display a message that a vehicle is smoking or is on fire, and; a symbol of the numbers “911” to display a message to call for help.

Many other symbols are possible, and these are only representative examples. A symbol of a flat tire could be used in some implementations. There may be many other possible descriptions and messages, as well, such as a message that something is hanging off a vehicle, a yellow display to indicate to others to use (or proceed with) caution, a red display to indicate to others to stop, a message telling a driver to turn their lights on, and the like. The logos and characters in these examples may not be in the actual message 22 displayed on display 20.

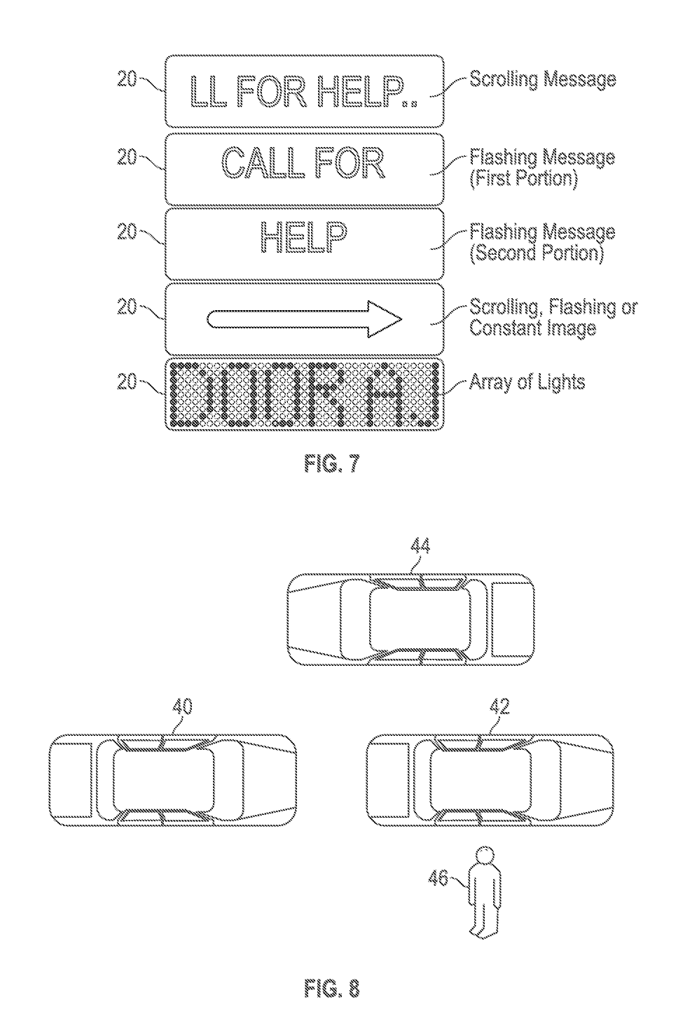

The display 20 may include any type of display, may include any colors, and the like. It may be a liquid crystal display (LCD), a light emitting diode (LED) display, a color super twisted nematic (CSTN) display, a thin film transistor (TFT) display, a thin film diode (TFD) display, an organic light emitting diode (OLED) display, an active-matrix OLED (AMOLED) display, or any other type of display. The display 20 may be a high definition display such that it can display high definition images, photos, video files and the like, or it may be a simple low definition display such as an array of LEDs as shown in the bottommost example of FIG. 7. Referring to FIG. 7, the display may display the message 22 in a scrolling manner (top image), in a flashing manner wherein different portions of the message display alternately (such as “CALL FOR” followed by “HELP,” as shown in the second and third images from the top of FIG. 7), a scrolling or flashing logo, as shown in the fourth image from the top of FIG. 7, and the like. In some cases the message could be a static message—instead of flashing or scrolling.

The system 2 may have the size of a conventional rear view mirror. In implementations the system 2 may have a size of about 10 inches wide by about 2 inches tall by about 1 inch thick, and rear side 8 may have dimensions of about 10 inches wide by about 2 inches tall.

In some implementations the system 2 may have a timeout functionality, or some other reset functionality, whereby a selected message is displayed for a predetermined (or user-set) amount of time or until a predetermined “reset” event occurs (such as turning the car off) which then causes the message to cease displaying. In such cases each message may be set to display for the same amount of time, or some messages may be set to display for longer amounts of time. For example an “EMERGENCY—HEADING TO HOSPITAL” message may be configured to display for a longer amount of time or until the car is turned off), while a “GO AHEAD” message may be configured to display for only a minute or even only a few seconds. In some implementations a user may select how long a message is to be displayed, such as through an initial setup, or may choose the display time at the time the message is selected. In some implementations a user could be notified when a message is about to cease displaying and the user could then select one of the selectors to indicate that the message should continue to be displayed for some preconfigured additional amount of time (or until a reset event occurs). In other implementations the message may be displayed until a user makes a selection to cease displaying the message.

While the implementations have generally been described herein as being used by a “driver,” it should be understood that such a rear view mirror system could also be implemented in a driverless vehicle. For example, a driverless vehicle may include a rear view mirror but may be operational without a user steering, pressing the gas, pressing the brake, etc., and the system 2 may be implemented with such a vehicle to display a message to other drivers or passengers of other vehicles or to pedestrians even though there is no “driver” of the vehicle displaying the message. Systems 2 may be configured to communicate with communication systems of vehicles (such as driverless or other smart vehicles) to coordinate automated messages. For example one user could press a “Report Accident Here” button of a system 2 when passing the scene of an accident and this message could be routed through the internet to alert nearby police and emergency personnel that an accident is nearby, and similarly messages may be displayed on the displays of nearby systems 2 to vehicles approaching the accident, such as by displaying “Accident Ahead” on the displays of systems 2 of vehicles of oncoming traffic that has just passed the accident, such as to alert vehicles that are currently approaching the accident, and so forth.

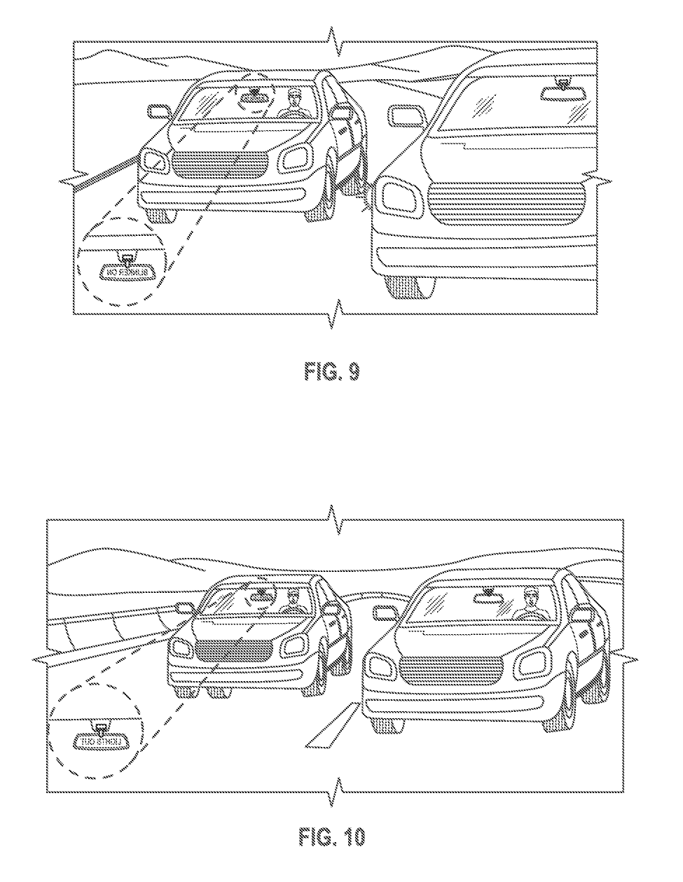

FIGS. 9-12 show additional representative examples of systems 2 and related methods. FIG. 9 shows, for example, a first car with a blinker on, and a second car displaying, on a system 2, the message “BLINKER ON” in reverse fashion. The driver of the first car may view the message through either his own rear view mirror or through a side mirror and may see the message “BLINKER ON” and may thus be notified to turn off his blinker. FIG. 10 shows a similar configuration but the displayed message is “LIGHTS OUT” in reverse format, thus notifying the driver of the first car that one or more or his lights are not functioning or are turned off, so that he may turn them on or have them repaired, and so forth.

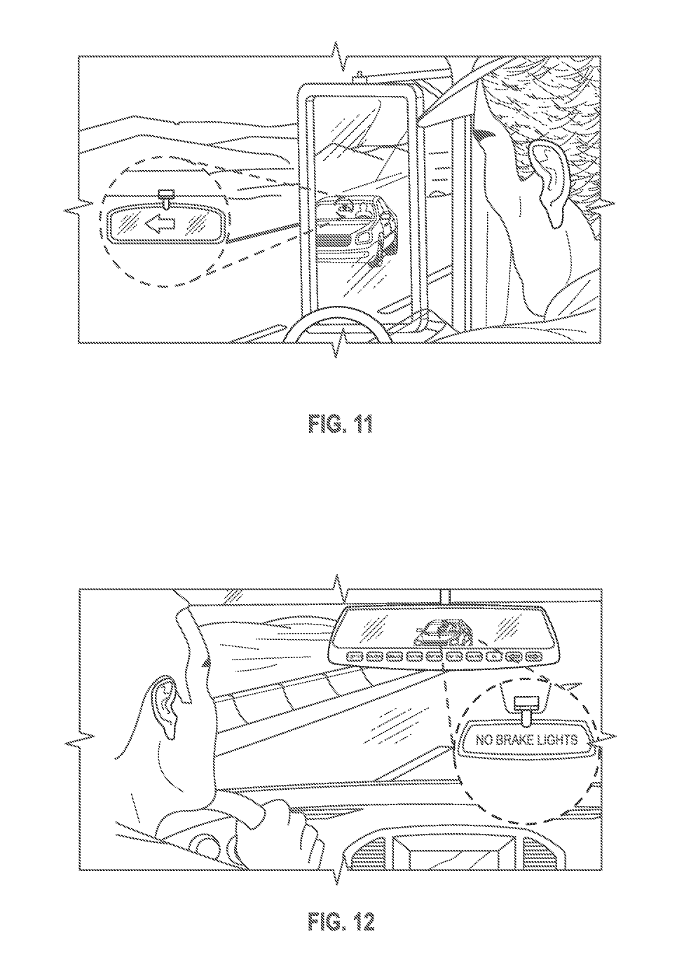

FIG. 11 shows a driver of a truck, such as a semi, or a bus, viewing a message from a system 2 from a car in a rearward position in an adjacent lane. The message being displayed is an arrow, which may be flashing or scrolling, and may indicate to the driver of the truck or bus that he may switch lanes in front of the rear vehicle. Another message or symbol could be used to indicate that the rear vehicle desires to pass (which could indicate to the forward vehicle to slow down).

FIG. 12 shows a driver of a vehicle viewing a display of a system 2 of a vehicle behind his, which through the rear view mirror displays in forward format as “NO BRAKE LIGHTS.” The message is displayed on the system 2 in reverse format but is reflected in forwards format through the forward driver's rear view mirror, and thus he sees the message correctly. This may notify the driver of the forward vehicle that he needs to fix or turn on one or more of his brake lights.

Naturally, many other examples of specific messages displayed to drivers, passengers, pedestrians, and so forth, are possible, and those described herein are just representative examples. Other messages such as “Dropped Something,” “Swerving,” “Unbuckled Child,” and so forth may be displayed, or any of the other messages that are described herein or in the drawings, may be displayed in similar formats and situations as those shown in FIGS. 9-12 and/or in other ways/situations.

A method of use of a rear view mirror system 2 may include receiving an input from a driver of a wheeled vehicle at a selector 14 on a rear side 8 of a body 4 of a rear view mirror system 2, the rear side facing the driver, and displaying, in response to the input, a message 22 on a front side 18 of the body of the rear view mirror system opposite the rear side, wherein the rear side of the body of the rear view mirror system includes a rear view mirror 10. The selector may be a push button and the input may be a push of the push button. The message may include one or more alphanumeric characters. The message may be displayed in reverse format so that it will be seen in forward format when viewed through a mirror, as has been described above. The method may include determining whether to display the message in forward or reverse format based on an input of the user (which may include the same input that causes the message to be displayed or may be another input, such as the pushing of another button). The message may include one or more or all of the following (and/or may be selected from the group consisting of): a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle, and; a message that another driver may proceed.

The rear view mirror system 2 and related methods may be made of conventional materials, components, subcomponents, and the like used to make goods similar to these in the art, such as, by non-limiting example, polymers, metals, ceramics, composites, glasses, integrated circuits, lights, wires, solders, screws, adhesives, and the like. Those of ordinary skill in the art will readily be able to select appropriate materials and manufacture these products from the disclosures provided herein.

In places where the description above refers to particular implementations of rear view mirror systems and related methods and implementing components, sub-components, methods and sub-methods, it should be readily apparent that a number of modifications may be made without departing from the spirit thereof and that these implementations, implementing components, sub-components, methods and sub-methods may be applied to other rear view mirror systems and related methods.

What is claimed is:

1. A rear view mirror system, comprising:
a body comprising:
a rear side comprising a rear view mirror;
a front side opposite the rear side, the front side comprising a display configured to display a message, and;
a selector, and;
an attachment member configured to attach the body to a front windshield of a wheeled vehicle;
wherein the display is configured to display the message in response to a driver of the wheeled vehicle selecting the selector.

2. The rear view mirror system of claim 1, wherein the selector is comprised on the rear side of the body.

3. The rear view mirror system of claim 1, wherein the message is selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle; a message that another driver may proceed, and; a customized message.

4. The rear view mirror system of claim 1, wherein the message is displayed in a reverse format so that it will be seen in a forward format when viewed through a mirror.

5. The rear view mirror system of claim 1, wherein the message is displayed in a forward format so that it will be seen in the forward format when viewed directly and not reflected through a mirror.

6. The rear view mirror system of claim 1, wherein the selector comprises a push button and comprises a description descriptive of the message.

7. The rear view mirror system of claim 1, wherein the message comprises one or more alphanumeric characters.

8. The rear view mirror system of claim 1, wherein the message comprises one or more non-alphanumeric symbols.

9. The rear view mirror system of claim 1, further comprising a coupler comprised on the body and configured to electrically couple the rear view mirror system with one of a power source and an external electronic device.

10. The rear view mirror system of claim 1, further comprising a camera on the front side of the body.

11. A rear view mirror system, comprising:
a body attached to a front windshield of a wheeled vehicle with an attachment member, the body comprising:
a rear side comprising a mirror;
a front side opposite the rear side and comprising a display facing a front of the wheeled vehicle, and;
a plurality of selectors, each selector causing the display to display one of a plurality of predetermined messages to a person outside and in front of the wheeled vehicle in response to being selected, at least one of the predetermined messages comprising alphanumeric characters;
wherein the rear view mirror system displays at least one of the predetermined messages in a reverse format so that it may be seen in a forward format when viewed through a mirror.

12. The rear view mirror system of claim 11, wherein the plurality of selectors comprises push buttons located on the rear side of the body.

13. The rear view mirror system of claim 11, wherein the plurality of predetermined messages comprises a message selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle, and; a message that another driver may proceed.

14. The rear view mirror system of claim 11, wherein at least one of the predetermined messages comprises one or more non-alphanumeric symbols.

15. The rear view mirror system of claim 11, further comprising a coupler comprised on the body to communicatively couple the rear view mirror system with an external electronic device.

16. The rear view mirror system of claim 11, further comprising a camera on the front side of the body.

17. A method of use of a rear view mirror system, comprising:
receiving an input from a driver of a wheeled vehicle at a selector on a rear side of a body of a rear view mirror system, the rear side facing the driver, and;
displaying, in response to receiving the input, a message on a front side of the body of the rear view mirror system opposite the rear side;
wherein the rear side of the body of the rear view mirror system comprises a rear view mirror.

18. The method of claim 17, wherein the message is selected from the group consisting of: a message that a light is out; a message that a light is broken; a message that a gas cap is off; a message that a gas panel is open; a message that a tire is flat; a message that a tire is low; a message that a blinker is on; a message that brights are on; a message that a door is ajar; a message that a trunk is ajar; a message that help is needed; a message that a vehicle may switch lanes; a message requesting to allow the wheeled vehicle to pass another wheeled vehicle and; a message that another driver may proceed.

19. The method of claim 17, wherein the message comprises one or more alphanumeric characters.

20. The method of claim 17, wherein the message is displayed in reverse format so that it will be seen in forward format when viewed through a mirror.
